(19) United States
(12) Patent Application Publication
(10) Pub. No.: US 2009/0117420 A1
(43) Pub. Date: May 7, 2009

(54) METHOD FOR JUDGING SYSTEM CONDITION IN FUEL CELL SYSTEM

(75) Inventor: Toru Nakakubo, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/260,490

(22) Filed: Oct. 29, 2008

(30) Foreign Application Priority Data
Nov. 7, 2007 (JP) 2007-289289

(51) Int. Cl. H01M 8/04

(52) U.S. Cl. 429/13; 429/25

(57) ABSTRACT

A method for rapidly judging abnormalities, such as a decrease in a residual fuel amount and valve leakage, using only one pressure detecting device, includes a step of detecting a pressure change per unit time by the pressure detecting device after switching the fuel cutoff device from a cutoff state to a flow state, and a step of judging, by a pressure state judging device, whether the fuel amount in a fuel tank is smaller than a predetermined residual amount by comparing the pressure change per unit time detected by the pressure detecting device with a predetermined pressure change.

### BACKGROUND OF THE INVENTION

1. Field of the Invention

The present invention relates to a method for judging system conditions in a fuel cell system. More specifically, it relates to a method for determining whether there are abnormalities, such as a decrease in the residual fuel amount, valve leakage, and the like, in a fuel cell system.

2. Description of the Related Art

A fuel cell is a power generation device in which fuel is supplied to an anode, and an oxidizer (generally air) is supplied to a cathode, so that electric power can be generated using a catalytic reaction at each of the electrodes.

The anode and the cathode are separated by an electrolyte. Ions and electrons are produced from the fuel on the anode by a catalytic reaction. The ions move to the cathode through the electrolyte, while the electrons reach the cathode through an external circuit. The ions, the electrons, and the oxidizer are combined on the cathode by the catalytic reaction. Energy produced in this process is extracted as electric power.

In particular, in recent years, polymer electrolyte fuel cells using polymer electrolyte membranes as electrolytes have been actively developed because of their low operating temperatures.

The fuel for the fuel cells of this type may be a gas, such as hydrogen, methane, or the like, or a liquid, such as methanol.

In addition, liquid fuel may be stored in a fuel tank, so that it can be converted into a form suitable for generating electric power, such as hydrogen gas, and supplied to a power generating portion.

When a gas filled in the fuel tank is used as the fuel, generally, a pressure sensor is provided on the fuel tank to detect a residual amount of the fuel by monitoring the pressure.

For example, Japanese Patent Laid-Open No. 2007-51682 discloses a gas supply apparatus including a plurality of fuel tanks, a cutoff value and a pressure-reducing value which are provided between the fuel tanks and a power generating portion, and a pressure sensor provided upstream of these valves in order to detect a residual amount of the fuel.

The gas supply apparatus further includes a flow meter provided downstream of the pressure-reducing valve in order to improve the detection accuracy of the residual amount.

JPA 2007-51682 also discloses using a pressure sensor instead of the flow meter as a device for measuring a flow rate. However, it is still necessary to detect the residual pressure with the pressure sensor provided upstream of the cutoff valve.

This is because of the advantage that the residual fuel pressure can be detected regardless of opening and closing of the cutoff valve.

Japanese Patent Laid-Open No. 9-22711 discloses a fuel cell system in which cutoff valves are provided upstream and downstream of a pressure sensor in order to detect a residual fuel amount based on the information from the pressure sensor and detect leakage of the upstream and downstream valves during starting.

This constitution is advantageous in that the two functions, i.e., detection of the residual fuel amount and detection of valve leakage, can be imparted by one pressure sensor.

Similarly, a device including a pressure sensor provided in a power generating portion of a fuel cell is known as a device for checking a fuel cell system.

For example, Japanese Patent No. 3663669 discloses a method of detecting a valve failure (leakage) by detecting the pressure between two valves in a closed state in a fuel cell power generation system. The valves are provided upstream and downstream of a fuel cell.

In addition, an anode flow path may be purged with an inert gas (fuel before reforming, nitrogen, air, or the like) when power generation is stopped to prevent deterioration of a catalyst in the fuel cell. In this case, the flow path is often purged with the fuel at the time of starting or stopping the operation of the cell.

Further, the fuel may be circulated or used in a dead end mode in order to improve the efficiency of fuel utilization and to decrease the size of the system. A polymer electrolyte membrane is known to slightly diffuse and allow water, water vapor, fuel, and air to permeate.

Therefore, water and water vapor, which are produced when power is generated, and air on the cathode side may permeate to the anode side, and these impurities may accumulate to decrease the power generation performance.

Therefore, the anode flow path is purged to discharge the accumulated impurities (nitrogen, water vapor, and the like).

In addition, the fuel in the anode flow path slightly permeates through the electrolyte membrane when the power generation is stopped, thereby gradually discharging the fuel to the outside. When the supply of fuel is stopped in stopping the power generation, the pressure in the anode flow path decreases.

For example, Japanese Patent Laid-Open Nos. 2004-179080 and 2004-179034 disclose methods for prohibiting the purging of a fuel cell when the pressure in an anode flow path is low during starting or stopping. This is aimed at preventing a backflow of air when a purge valve is opened under pressure insufficient to purging. In such a case, a pressure sensor provided in the fuel flow path of a power generating portion is used for making a judgment on control.

Fuel cells attract attention as energy sources for automotive and residential power generators, as well as small electric devices.

The reason why the fuel cells are useful as power sources for small electric devices is that the available energy supply per volume and per weight is greater than those of conventional lithium ion secondary batteries.

In particular, in order to obtain a high power output, it is optimal to use hydrogen as fuel for fuel cells. However, hydrogen is gaseous at room temperature. Thus, a technique is necessary for storing hydrogen at a high density in a small fuel tank.

Hydrogen may be stored, for example, in a high-pressure tank, or using a hydrogen storing alloy or chemical hydride. Also, hydrogen may be produced by reforming methanol, which is stored.

Examples of the hydrogen storing alloy include LaNi₅ and the like. Examples of the chemical hydride include sodium borohydride and the like. There is also a method of producing hydrogen by adding water to a metal powder.

The use of the hydrogen storing alloy is characterized in that the energy capacity per mass is small, but the energy capacity per volume is large because of the high specific gravity.

In addition, the hydrogen dissociation pressures of some hydrogen storing alloys are close to atmospheric pressure at room temperature. Therefore, the hydrogen storing alloy is suitable for fuel cells in small electric devices, which are preferred to have small control systems for miniaturization.

The dissociation pressure of the hydrogen storing alloy generally varies with temperature.

The hydrogen storage-release characteristics of the hydrogen storing alloy have a plateau region in which the pressure is substantially constant within a predetermined range of storage amounts.

Therefore, it is often difficult to estimate the residual fuel amount by measuring the pressure. However, when the residual fuel amount is very small, the release pressure of the hydrogen storing alloy deviates from the plateau region and begins to decrease. This is sufficient to detect that the fuel has nearly run out.

A hydrogen release reaction of the hydrogen storing alloy is generally endothermic. Thus, the temperature of a fuel tank decreases with the release of the fuel.

However, the equilibrium pressure of the hydrogen storing alloy decreases as the temperature decreases. Therefore, even if hydrogen remains in the fuel tank, the hydrogen pressure in the fuel tank may decrease due to a decrease in temperature of the fuel tank with a decrease in temperature of the external environment and hydrogen release.

In addition, the amount of hydrogen stored in or released from the hydrogen storing alloy may be decreased by the formation of an oxide film on a surface or impurity adsorption thereon.

Therefore, when the hydrogen storing alloy is used, particularly when the pressure in the fuel tank decreases, it is necessary to prevent hydrogen from mixing with impurity gases, such as air, in the fuel tank by opening a purge valve or a cutoff valve.

Further, when the pressure in a fuel tank is higher than the set pressure of a pressure-reducing valve provided between a pressure sensor and a fuel tank, it is difficult to estimate a residual amount from a value provided by the pressure sensor, because the secondary pressure of the pressure-reducing value becomes equal to the set pressure.

However, when the residual amount decreases to reduce the pressure in the fuel tank below the set pressure of the pressure-reducing valve, the secondary pressure of the pressure-reducing valve is equal to the primary pressure.

Therefore, the pressure sensor provided downstream of the pressure-reducing valve can detect that the fuel has nearly run out.

For example, Japanese Patent Laid-Open No. 2003-229160 discloses a method for detecting the depletion of fuel by providing a pressure sensor downstream of a pressure-reducing valve when a hydrogen storing alloy is used in a fuel tank of a fuel cell in a fuel cell system for a small electric device.

In any one of the above-mentioned conventional examples, in a fuel cell system including a fuel cutoff device provided in a fuel flow path for supplying fuel to a fuel cell, a configuration for more rapidly judging an abnormal condition, such as a decrease in the residual amount of the fuel, valve leakage, or the like, using a pressure detecting device, may be further improved.

For example, Japanese Patent Laid-Open No. 2007-51682 and Japanese Patent No. 3663669 requires pressure sensors respectively provided upstream and downstream of the cutoff valve in order to detect the residual fuel amount and a valve abnormality. Thus, the two pressure sensors are needed to satisfy the two functions.

In other words, in Japanese Patent Laid-Open No. 2007-51682, the residual fuel amount is detected by the pressure sensor provided upstream of the cutoff valve.

The pressure sensor provided upstream of the cutoff valve cannot detect an abnormality even when leakage occurs in a valve in a fuel cell system, because the pressure of the fuel tank is constantly applied to the pressure sensor.

In Japanese Patent No. 3663669, a valve abnormality (leakage) in a fuel cell system is detected by the pressure sensor provided downstream of the cutoff valve.

When the residual fuel amount is detected by the pressure sensor provided downstream of the cutoff valve, the pressure sensor may indicate a value different from the residual pressure in the fuel tank when the cutoff valve is closed.

In particular, when a purge valve is opened or power generation is performed after the cutoff valve is closed, the sensor indicates a value lower than the fuel residual pressure because the pressure in a hydrogen flow path is decreased.

Therefore, the residual fuel pressure may not be accurately detected by the pressure sensor provided downstream of the cutoff valve.

Consequently, in order both to detect the fuel residual pressure and to detect a valve abnormality, it is necessary to separately provide respective pressure sensors upstream and downstream of the cutoff valve.

The fuel cell system described in Japanese Patent Laid-Open No. 2003-229160 is capable of detecting fuel depletion using a pressure sensor provided downstream of the pressure-reducing valve.

However, in this fuel cell system, a fuel cutoff device, such as a connector, for making the cutoff valve and the fuel tank detachable and enhancing the durability and convenience of the fuel cell, is not provided between the fuel tank and the pressure sensor.

The pressure-reducing valve has a controlled opening to maintain the pressure on the downstream side at a predetermined level and mainly operates in a passive manner.

That is, the pressure-reducing valve is opened when the pressure on the downstream side is lower than a set value and is closed when the pressure is higher than the set value.

The cutoff value is an active valve, which can be arbitrarily opened and closed regardless of the pressure and flow rate on the upstream or downstream side.

For example, in a fuel cell, fuel is not consumed in the anode flow path when power generation is stopped. Thus, the pressure-reducing valve is closed when the pressure in the anode flow path is at a set value.

In this case, however, when the purge valve is opened to release the fuel in the anode and replace it with air, or during a long-term stoppage, the fuel permeates through the electrolyte membrane to decrease the pressure in the anode flow path.

As a result, the pressure-reducing valve is opened to maintain the pressure in the anode flow path. This operation may be undesirable from the viewpoint of preventing the deterioration in the fuel cell and effective utilization of the fuel.

In addition, a fuel cell for a small electric device includes a detachable fuel tank so that when the fuel runs out, power generation can be immediately started by replacing the empty fuel tank with a new tank, thereby enhancing convenience.

In this case, a detachable connector is provided between the fuel tank and the power generating portion of the fuel cell. The connector may have a built-in stop valve device which is closed when disconnected and opened when connected.

As described above, when the fuel cutoff device, such as the cutoff valve or the connector, is provided between the fuel tank and the power generating portion of the fuel cell in the fuel cell system, the durability and convenience of the fuel cell can be enhanced.

When using this fuel cutoff device, the anode flow path of the fuel cell is opened to air when the fuel cell is stopped, and the pressure in the anode flow path decreases to near atmospheric pressure. Also, when the anode flow path is not opened to air, after a long period of time elapses, the pressure in the anode flow path reaches approximately atmospheric pressure due to a decrease in the fuel and air by permeation through the electrolyte membrane.

In Japanese Patent Laid-Open No. 9-22711, the cutoff valves are provided both upstream and downstream of the pressure sensor, and the pressure-reducing valve is further provided downstream of the cutoff valve.

In this case, it is necessary to provide the cutoff valves upstream and downstream of the pressure sensor in order to detect valve leakage or detect the residual fuel amount before the fuel is supplied to the fuel cell.

In other words, when the cutoff valve is provided only upstream of the pressure sensor and not provided downstream, a value detected by the pressure sensor is decreased when the cutoff valve is opened to supply the fuel to the fuel cell, thereby making it difficult to rapidly detect a decrease in the residual fuel amount. Therefore, the structure as disclosed in Japanese Patent Laid-Open No. 9-22711 requires the cutoff valves upstream and downstream of the pressure sensor.

Further, the fuel in the anode flow path is discharged to the outside during purging. Therefore, a reading provided by the pressure senor may be decreased by purging depending on the structure of the flow path and the mounting position of the pressure sensor.

Japanese Patent Laid-Open Nos. 2004-179080 and 2004-179034 disclose a method of prohibiting the purging when the pressure in the anode flow path is low at the time of starting or stopping power generation. However, a method of prohibiting the purging when the pressure is decreased with the release of the fuel during purging is not disclosed. Also not disclosed is that a decrease in the residual fuel amount and an abnormality, such as valve leakage, can be detected more rapidly by a pressure detecting device.

### SUMMARY OF THE INVENTION

The present invention aims at providing a method for judging a condition in a fuel cell system that includes a fuel cutoff device provided in a fuel flow path for supplying fuel to a fuel cell, the method being capable of rapidly judging abnormalities such as a decrease in a residual fuel amount, valve leakage, and the like using a pressure detecting device, thereby decreasing the size and the cost of the system.

The present invention provides a method for judging a condition in a fuel cell system configured as described below.

That is, the present invention provides a method for judging a condition in a fuel cell system that includes a fuel cutoff device provided in a fuel flow path for supplying fuel to a fuel cell from a fuel tank, a pressure detecting device provided downstream of the fuel cutoff device, and a pressure condition judging device for judging a pressure based on information from the pressure detecting device. The method includes a step of detecting a pressure change per unit time within a predetermined amount of time by the pressure detecting device after the fuel cutoff device is changed from a cutoff state to a flow state, and a step of judging, by the pressure condition judging device, whether an abnormality occurred because the amount of the fuel in the fuel tank is smaller than a predetermined residual amount by comparing the pressure change per unit time detected by the pressure detecting device with a predetermined pressure change.

According to the present invention, it is possible to judge a condition in a fuel cell system that includes a fuel cutoff device provided in a fuel flow path for supplying fuel to a fuel cell, by rapidly determining whether abnormalities, such as a decrease in the residual fuel amount, valve leakage, and the like, have occurred using a pressure detecting device, thereby reducing the size and the cost of the system.

Other features of the present invention will become apparent from the following description of exemplary embodiments with reference to the attached drawings.

### BRIEF DESCRIPTION OF THE DRAWINGS

FIG. 1 is a schematic illustration of a first configuration example of a fuel cell system according to a first embodiment of the present invention.

FIG. 2 is a schematic illustration of a second configuration example of the fuel cell system according to the first embodiment of the present invention.

FIG. 3 is a schematic illustration of a third configuration example of the fuel cell system according to the first embodiment of the present invention.

FIG. 4 is a schematic illustration of a fourth configuration example of the fuel cell system according to the first embodiment of the present invention.

FIG. 5 is a flowchart illustrating an example of a method for judging a low-pressure abnormality according to the first embodiment of the present invention.

FIGS. 6A and 6B are flowcharts each illustrating a high-pressure abnormality according to the first embodiment of the present invention.

FIGS. 7A and 7B graphs illustrating pressure changes with time at the start of supplying the fuel according to the first embodiment of the present invention.

FIG. 8 is a flowchart illustrating a method for judging a decrease in residual amount at the time of supplying fuel to a fuel cell according to the first embodiment of the present invention.

FIG. 9 is a schematic illustration of a first configuration example of a fuel cell system according to a second embodiment of the present invention.

FIGS. 10A and 10B are flowcharts illustrating a process of purging a fuel cell during power generation and during a stoppage, respectively, according to the second embodiment of the present invention.

FIG. 11 is a schematic illustration of a second configuration example of the fuel cell system according to the second embodiment of the present invention.

FIG. 12 is a schematic illustration of a third configuration example of the fuel cell system according to the second embodiment of the present invention.

FIG. 13 is a flowchart illustrating judgment criteria for a low-pressure abnormality in purging of the fuel cell according to the second embodiment of the present invention.

FIG. 14 is a schematic illustration of a fourth configuration example in which a hydrogen sensor is provided as a fuel sensor according to the second embodiment of the present invention.

FIG. 15 is a flowchart illustrating a method for judging a low-pressure abnormality according to the second embodiment of the present invention.

FIG. 16 is a flowchart illustrating a second process of purging a fuel cell according to the second embodiment of the present invention.

FIGS. 17A and 17B each illustrate flow path resistance and pressure of each portion according to the second embodiment of the present invention.

FIG. 18 is a graph illustrating pressure changes with time at the start of supply of fuel according to a third embodiment of the present invention.

FIGS. 19A and 19B are flowcharts each illustrating a starting process of a fuel cell according to the third embodiment of the present invention.

FIG. 20 is a schematic illustration of a configuration of a fuel cell system in an example of the present invention.

### DESCRIPTION OF THE EMBODIMENTS

Preferred embodiments of the present invention are described below.

### First Embodiment

In a first configuration example of a fuel cell system according to the first embodiment of the present invention, a cutoff vale is provided as a fuel cutoff device in a fuel flow path.

In this embodiment, a method for judging system conditions in a fuel cell system is applied. The fuel cell system includes a fuel cutoff device provided in a fuel flow path for supplying fuel to a fuel cell from a fuel tank, a pressure detecting device provided downstream of the fuel cutoff device, and a pressure condition judging device for judging a pressure condition on the basis of information provided by the pressure detecting device.

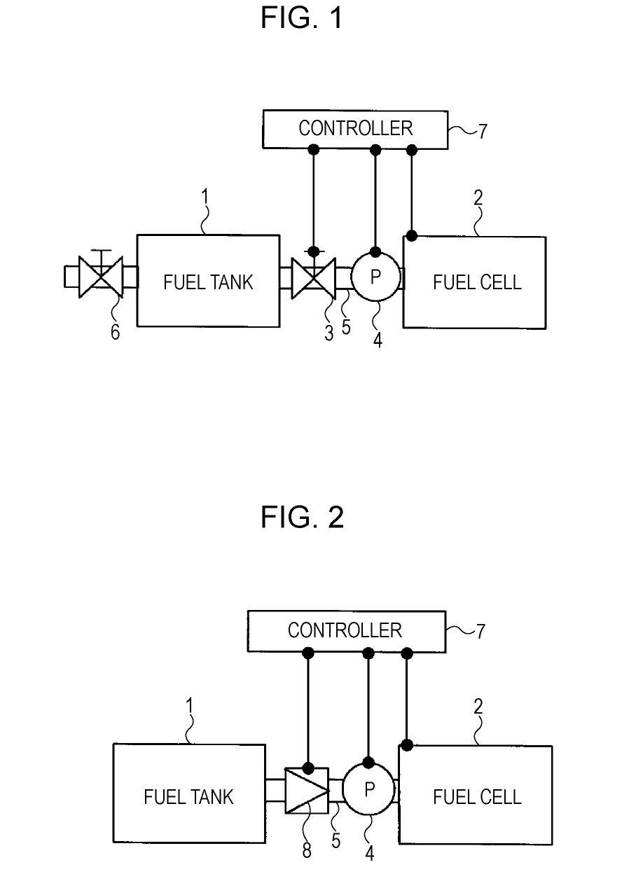

FIG. 1 illustrates the first configuration example of the fuel cell system according to the first embodiment of the present invention.

In FIG. 1, reference numeral 1 denotes a fuel tank, reference numeral 2 denotes a fuel cell, reference numeral 3 denotes a cutoff value (a fuel cutoff device), reference numeral 4 denotes a pressure sensor (pressure detecting device), reference numeral 5 denotes a fuel flow path, reference numeral 6 denotes an auxiliary fuel valve, and reference numeral 7 denotes a controller (pressure condition judging device).

In the first configuration example of this embodiment, the fuel tank 1 is provided with the auxiliary fuel valve 6 for filling the fuel tank 1 with hydrogen as the fuel. The fuel is supplied from the fuel tank 1 to the fuel cell 2 through the fuel flow path 5.

In addition, in the first configuration example, the cutoff valve 3 is provided in the fuel flow path 5 as the fuel cutoff device for opening and closing the fuel flow path 5. Further, the pressure sensor 4 is provided as the pressure detecting device downstream of the cutoff valve 3.

In the first configuration example, the pressure sensor 4 may also be provided downstream of the fuel cell 2 or both components may be provided in parallel. Although the fuel flow path 5 has a dead-end configuration, the fuel tank side of the fuel flow path 5 is defined as being upstream, and the opposite side is defined as being downstream. Generally, the terms “upstream” and “downstream” as used here refer to the position of components based on the fuel flow direction, i.e., from the fuel container (located upstream) to the fuel cell (located downstream).

While the internal configuration of the fuel cell 2 is not shown in FIG. 1, the fuel supplied to the fuel cell 2 is introduced to an anode electrode of the fuel cell 2 and air is supplied to a cathode electrode. The air may be supplied by natural diffusion or using a fan.

The electric power generated is extracted through the electrodes. A signal from the pressure sensor 4 is sent to the controller 7 that has the pressure condition judging device. The controller 7 monitors the reacting provided by the pressure sensor 4 and a power generation state of the fuel cell 2 and controls actuators, such as the cutoff valve 3 and the fan, according to the circumstances.

Next, a second configuration example of the fuel cell system according to the first embodiment is described. In this configuration example, a connector is provided as a fuel cutoff device in a fuel flow path.

FIG. 2 is a drawing illustrating the second configuration example according to the first embodiment of the present invention. In FIG. 2, reference numeral 8 denotes a connector for detachably attaching a fuel tank 1. The second configuration example is the same as the first configuration example except that the connector 8 is provided instead of the cutoff valve 3.

In the second configuration example shown in FIG. 2, the connector 8 functions as the fuel cutoff device by attaching and detaching the fuel tank 1. In addition, a connection state of the connector 8 is detected by the controller 7. When no fuel is left in the fuel tank 1, the fuel tank 1 is detached using the connector 8 and a new fuel tank is attached.

In order to prevent air inflow when the fuel tank is detached, a stop valve (check valve) can be provided on at least the fuel tank side of the connector. Not only the connector 8, but also the cutoff valve 3 shown in FIG. 1 may be provided. Although the fuel tank shown in FIG. 2 is not provided with an auxiliary fuel valve, the auxiliary fuel valve may be provided as in FIG. 1.

Next, a third configuration example of the fuel cell system according to the first embodiment is described. In this configuration example, a connector and a cutoff valve are provided as a fuel cutoff device in a fuel flow path. A temperature sensor is also provided.

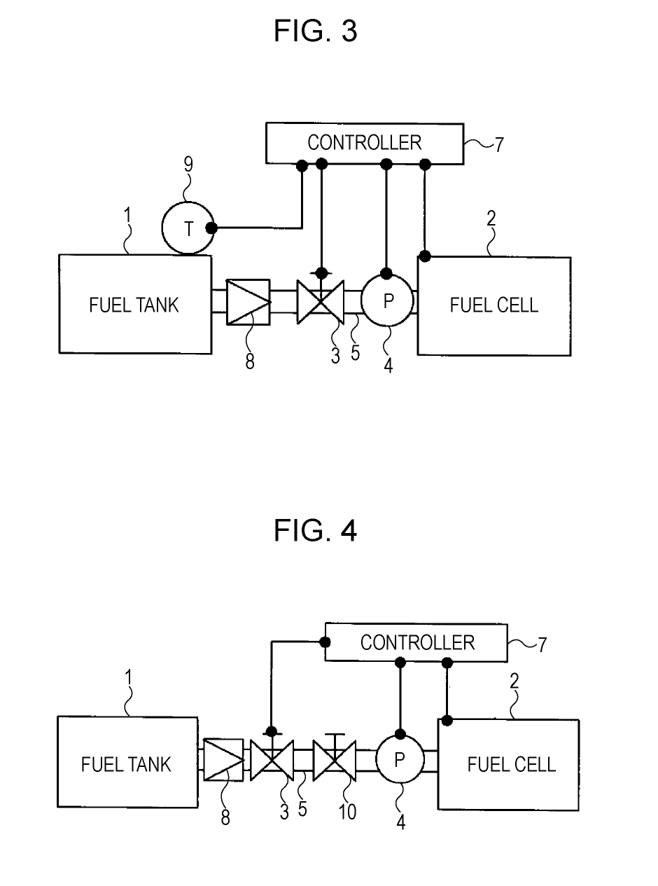

FIG. 3 is a drawing schematically illustrating the third configuration example according to the first embodiment of the present invention. In FIG. 3, reference numeral 9 denotes the temperature sensor, so that the temperature of a fuel tank 1 can be detected. The third configuration example is substantially similar the first and second configuration examples shown in FIGS. 1 and 2, respectively, except that the connector and the cutoff valve are provided as the fuel cutoff device in the fuel flow path. Also, as noted above, the temperature sensor 9 is provided.

The pressure in the fuel tank 1 varies with temperature. In particular, when a hydrogen storing alloy is used in the fuel tank 1, temperature-induced pressure changes are greater than when gaseous hydrogen is stored in a container. Further, a hydrogen release reaction of the hydrogen storing alloy is endothermic. Thus, the temperature of the fuel tank 1 may decrease as hydrogen consumed, decreasing the hydrogen pressure in the fuel tank 1.

Therefore, as in the third configuration example, the temperature sensor 9 is provided, so that when the pressure in the fuel tank 1 becomes abnormal, a determination can be made as to whether this abnormal pressure is due to a temperature change.

Further, a determination may be made as to whether a drop in temperature is due to hydrogen consumption during power generation by detecting an opened-closed state of a valve and an output state (mainly a current) of the fuel cell. The temperature sensor 9 can be attached near the fuel tank, but the atmospheric temperature or the temperature of the fuel cell 2 may be measured and used for correction or substitution.

Next, a fourth configuration example of the fuel cell system according to the first embodiment is described. In this configuration example, a connector and a cutoff valve are provided as a fuel cutoff device in a fuel flow path. A control valve is also provided.

FIG. 4 is a drawing schematically illustrating the fourth configuration example according to the first embodiment of the present invention. In FIG. 4, reference numeral 10 denotes the control valve, which can be provided as a pressure control valve or a flow rate control valve. For example, when the control valve is provided as the pressure control valve, a passive pressure-reducing valve (pressure regulator) for maintaining the secondary pressure constant can be used.

A positional relationship between the control valve 10, the fuel cutoff device (the connector 8 and the cutoff valve 3), and the pressure sensor 4 is not particularly limited. However, for example, when leakage of the control valve is detected by the pressure sensor 4, as shown in FIG. 4, the fuel cutoff device, the control valve 10, and the pressure sensor 4 are arranged in that order from the fuel tank side.

Then, control of the fuel cell on the basis of a detection value of the pressure sensor 4 is described. First, the control under a constant pressure after a sufficient amount of time elapsed from the start of the fuel supply is described with respect to detection of a pressure change per unit time within a predetermined period of time after the fuel cutoff device has been switched from a cutoff state to a flow state.

Under such conditions, when the control valve 10 is not installed upstream of the pressure sensor 4, the pressure sensor 4 detects substantially constant pressure in the fuel tank 1. When the control valve 10 is installed, however, the pressure sensor 4 detects a substantially constant control pressure. When the pressure detected by the pressure sensor 4 is lower than the predetermined value P_{L}, the controller 7 judges that a low-pressure abnormality has occurred. On the basis of this judgment, a user is informed of this condition and power generation is stopped.

Possible causes of the low-pressure abnormality include a decrease in the residual fuel amount, a failure in which the cutoff valve 3 is not opened even though an opening command has been issued, a connection of the connector 8 is defective, a decrease in the temperature of the fuel tank 1, leakage of the control valve 10, and the like.

Therefore, in order to make a more accurate judgment, several detection methods may be combined. For example, as shown in FIG. 3, when the temperature sensor is provided, the temperature can be measured by the temperature sensor. Thus, a determination may be made using the temperature data as to whether the abnormality is due to a temperature decrease. Further, a determination as whether the abnormality is due to a failure of the cutoff valve 3 can be judged by measuring a pressure change between opened and closed states of the cutoff valve 3. If there is neither a drop in temperature nor a valve abnormality, it is judged that the residual amount of the fuel decreases.

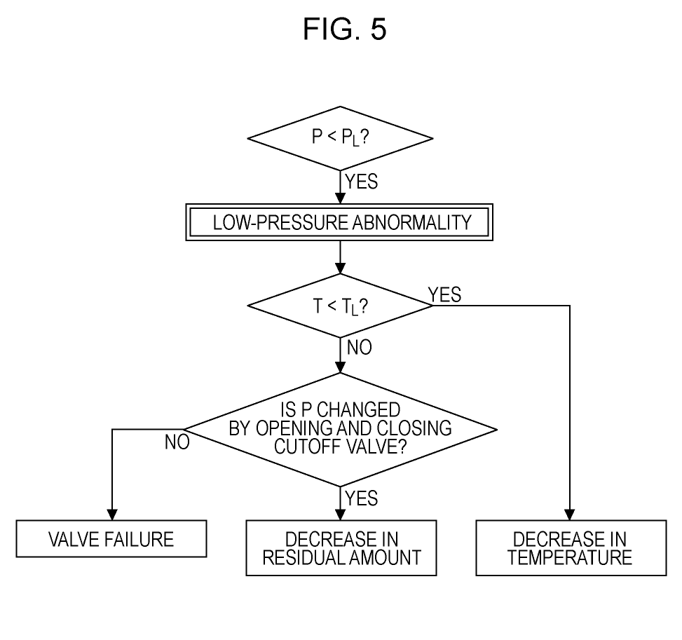

FIG. 5 is a flowchart illustrating an example of a method for judging a low-pressure abnormality. First, when the value P provided by the pressure sensor 4 is lower than a predetermined value, i.e., predetermined value P_{L}, for example, it is judged that the amount of fuel in the fuel tank is smaller than the predetermined residual amount. Thus, it is judged that a low-pressure abnormality occurred.

Next, when the temperature T of the temperature sensor 9 is lower than T_{L}, it is judged that the abnormality is due to a decrease in temperature. The pressure of the fuel in the fuel tank varies with temperature T. Therefore, a judgment is not made on the basis of the predetermined value T_{L}. The predetermined value P_{L} is corrected for the temperature T, and when P is higher than corrected P_{L}, it is judged that the temperature decreased. As a result, it is possible to judge whether a pressure decrease is due to a decrease in temperature or a combination of a decrease in temperature and a decrease in the residual amount.

Next, when it is judged that the abnormality is not due to a decrease in temperature, an open/closure command is given to the cutoff valve to compare pressure changes with time in an open command state and those in a close command state. Since the fuel is consumed during power generation, even when the amount of the fuel is insufficient or the cutoff valve 3 is not opened due to a failure, the pressure decreases with time.

However, when the cutoff valve 3 is not opened due to a failure, the pressure changes over time in an open command state are the same as in a close command state. When the control valve 10 is disposed between the cutoff valve 3 and the pressure sensor 4, it can be judged that the control valve 3 or the cutoff valve 3 is not opened due to a failure.

However, when the pressure rapidly decreases in a close command state, it is judged that the residual fuel amount decreased. In addition, when the amount of the supplied fuel decreases, the output and electromotive force of the fuel cell also decrease. Therefore, in judging whether the low-pressure abnormality is due to a decrease in the residual amount, the output or electromotive force of the fuel cell is also measured so that the accuracy of the judgment can be further increased even when the pressure sensor has an offset error.

For example, when the pressure detected by the pressure detecting device is lower than the predetermined pressure and at least one of the voltage and output of the fuel cell is lower than the predetermined voltage or output, it is judged that an abnormality occurred.

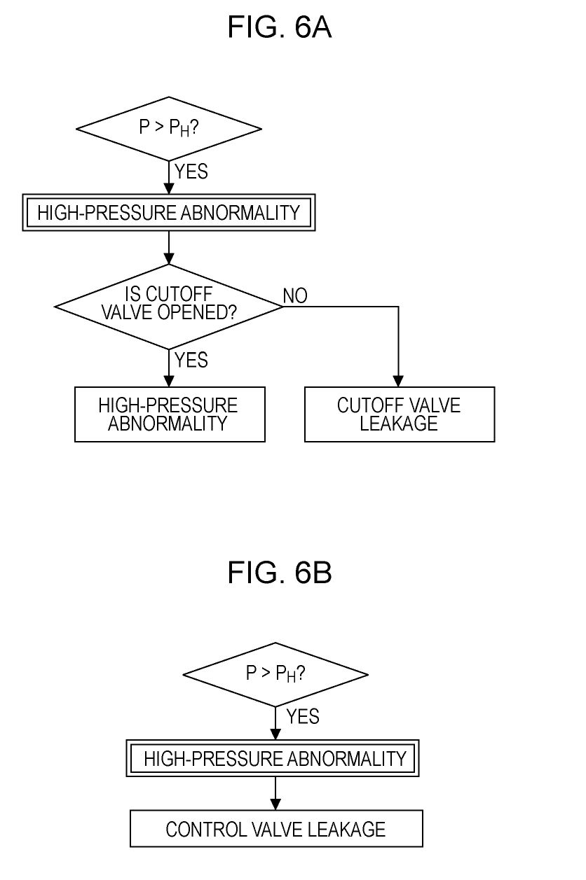

However, as shown in FIGS. 6A and 6B, when the value detected by the pressure sensor 4 is higher than the predetermined value P_{H}, the controller 7 judges there to be a high-pressure abnormality. When the control valve 10 is disposed upstream of the pressure sensor, the high-pressure abnormality is possibly due to leakage of the control valve 10 (FIG. 6A). In this case, the predetermined value P_{H} can be set to a pressure lower than the control pressure of the control valve under normal conditions. If the cutoff valve 3 is opened when the control valve 10 is not provided or provided downstream of the pressure sensor 4, it is judged that the pressure is increased by an increase in temperature of the fuel tank 1. If the cutoff valve 3 is closed, it is judged that leakage occurs in the cutoff valve 3 (FIG. 6B).

The method for judging the low-pressure abnormality or the high-pressure abnormality under a stationary pressure condition after a sufficient amount of time has passed from the start of fuel supply is described above. The abnormality judgment at the start of the operation of the fuel cell (opening of the fuel cutoff device) is described below.

The abnormality judgment at the start is made before a sufficient amount of time passes from the start of supplying the fuel to make the transition to a stationary pressure condition. When the cutoff valve 3 is closed or the connector 8 is disconnected, the value from the pressure sensor does not reflect the pressure in the fuel tank 1. In addition, when the connector 8 is disconnected, the pressure in the fuel flow path may approach atmospheric pressure at the end of power generation. However, this is irrelevant to the residual amount of the fuel in the fuel tank 1. Therefore, when the cutoff valve 3 is closed or the connector 8 is disconnected, even if the value provided by the pressure sensor 4 is lower than the predetermined value P_{L}, this state is not judged a low-pressure abnormality. In particular, when power generation by the fuel cell is stopped, power consumption can be decreased by turning off the pressure sensor.

A method for detecting a decrease in the residual amount of fuel in the fuel tank 1 in a process in which the fuel passes through the fuel flow path 5 to increase the value detected by the pressure sensor 4 after the cutoff valve 3 is opened and the fuel tank 1 is connected though the connector 8 is described below.

When a throttle having an orifice shape is present in a flow path, the flow rate of a fluid in the orifice and the pressure difference in the orifice generally have the following relationship:

$$Q = {C}_{d} A \sqrt{\frac{2}{ρ} ( {P}_{1} - {P}_{2} )} , \qquad Equation ( 1 \text{-} 1 )$$

wherein
C_{d}: flow coefficient (generally 0.7)
ρ: fluid density
P₁: upstream pressure of orifice
P₂: downstream pressure of orifice
A: sectional area of flow path.

When the volume downstream of the pressure sensor is V, V, Q, and P₂ have the following relationship:

$${P}_{N} Q = V \frac{d {P}_{2}}{d t} , \qquad Equation ( 1 \text{-} 2 )$$

wherein P_{N} is 1 atm=101325 Pa. The equations (1-1) and (1-2) are solved as simultaneous equations to obtain the following equation of the changes of P₂ with time:

$${P}_{2} = - \frac{1}{4} {( \frac{{P}_{N}}{V} {C}_{d} A \sqrt{\frac{2}{ρ}} t - 2 \sqrt{{P}_{1} - {P}_{20}} )}^{2} + {P}_{1} wherein ( t \leq \frac{2 \sqrt{{P}_{1} - {P}_{20}}}{\frac{{P}_{N}}{V} {C}_{d} A \sqrt{\frac{2}{ρ}}} ) , \qquad Equation ( 1 \text{-} 3 )$$

wherein P₂₀ is a value of P₂ at t=0.

According to equation (1-3), when

$$t = \frac{2 \sqrt{{P}_{1} - {P}_{20}}}{\frac{{P}_{N}}{V} {C}_{d} A \sqrt{\frac{2}{ρ}}}$$

P₂ is a constant value. Further, equation (1-3) is differentiated to obtain the following equation of the changes of P₂ with time:

$$\frac{d {P}_{2}}{d t} = - \frac{1}{2} {( \frac{{P}_{N}}{V} {C}_{d} A \sqrt{\frac{2}{ρ}} )}^{2} + \frac{{P}_{N}}{V} {C}_{d} A \sqrt{\frac{2}{ρ} ( {P}_{1} - {P}_{20} )} . \qquad Equation ( 1 \text{-} 4 )$$

For example, when the fuel is hydrogen (ρ=0.0899 kg/m³) and the fuel cutoff device or the control value is provided between the fuel cutoff device and the pressure sensor 4, the flow resistance of the fuel flow path from the control valve to the pressure sensor 4 equals that of an orifice throttle with a diameter of 0.04 mm, and the volume V of a downstream portion is 1 cm³.

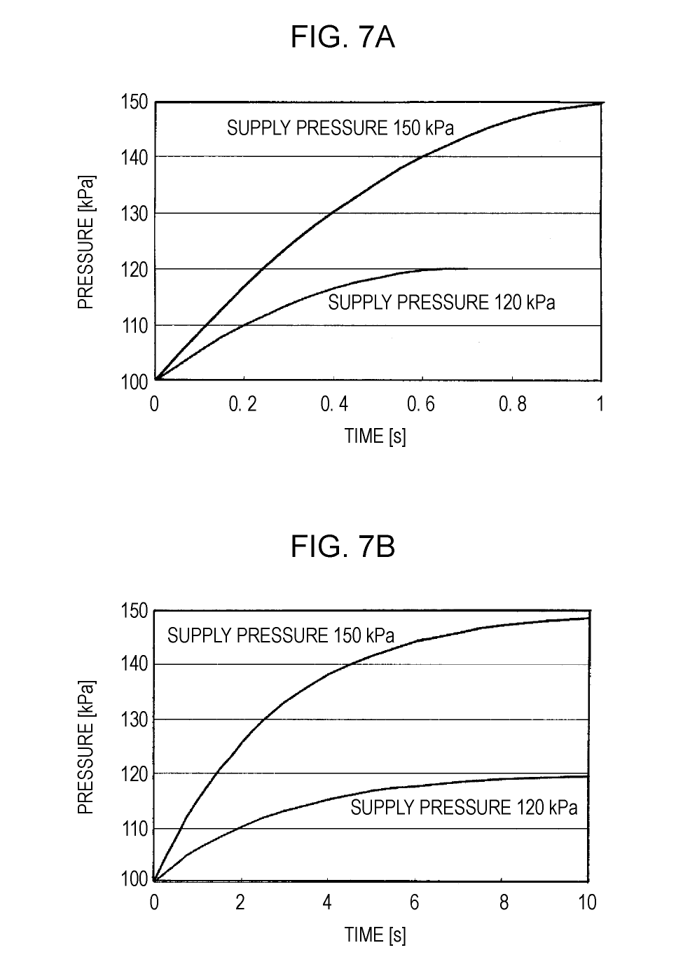

When the pressure value P₂₀ detected by the pressure sensor 4 before the fuel is supplied is 100 kPa, and the supply pressure P₁ (pressure after control by the control value) from the fuel tank 1 is 150 kPa (normal condition) or 120 kPa (when the fuel residual amount decreases), changes in the value (P₂) with time as detected by the pressure sensor 4 from the start of fuel supply at t=0 are as shown in FIG. 7A. The pressure in the fuel flow path 5 gradually increases with the supply of the fuel and the pressure of the pressure sensor 4 becomes equal to the supply pressure after 1 second and about 0.7 second when the supply pressure of the fuel is 150 kPa and 120 kPa, respectively. For example, when the pressure in the fuel tank 1 is less than 130 kPa, the value detected by the pressure sensor 4 is less than 130 kPa for about 0.4 second from the start of the fuel supply even when a sufficient amount of the fuel remains (150 kPa). Therefore, during this time, the residual fuel amount cannot be accurately determined by the value detected by the pressure sensor 4. That is, in this case, the method for judging the low-pressure abnormality of the pressure sensor described above on the basis of the flowchart of FIG. 5 becomes effective after 0.4 second or more elapse from at least the start of supplying the fuel. However, pressure changes from t=0.1 second to t=0.2 second are 8 kPa and 4.6 kPa when the supply pressure of the fuel is 150 kPa and 120 kPa, respectively. For example, when a pressure change k for judging a decrease in the residual amount within this time range is 6 kPa, a decrease in the residual amount can be detected by a pressure change over time. In this case, as in the flowchart shown in FIG. 5, the outside temperature may be measured to account for the influence of temperature on pressure changes.

This system is capable of detecting a decrease in the residual amount until t is about 0.6 second. In other words, as shown in FIG. 8, a decrease in the residual amount can be judged by a pressure change over time up to the predetermined time t₁ from the start of fuel supply and can be judged by a pressure value after the predetermine time t₂. In this case, t₁ and t₂ may be different values or the same value.

For example, in the case shown in FIG. 7A, t₁ and t₂ can be set to 0.4 second. While when a choke is present as a resistance form in a flow path, the following equation is obtained:

$$Q = \frac{π {D}^{4}}{128 μ L} ( {P}_{1} - {P}_{2} ) , \qquad Equation ( 2 \text{-} 1 )$$

wherein
μ: viscosity coefficient
P₁: upstream pressure of choke
P₂: downstream pressure of choke
D: orifice diameter
L: orifice length.
   When the volume downstream of the pressure sensor is V, V, Q, and P₂ have the following relationship:

$${P}_{N} Q = V \frac{d {P}_{2}}{d t} , \qquad Equation ( 2 \text{-} 2 )$$

wherein P_{N} is 1 atm=101325 Pa. Equations (2-1) and (2-2) are solved as simultaneous equations to obtain the following equation of the changes of P₂ with time:

$${P}_{2} = {P}_{1} + ( {P}_{20} - {P}_{1} ) {e}^{\frac{{P}_{N}}{V} \frac{π {D}^{4}}{128 μ L} t} , \qquad Equation ( 2 \text{-} 3 )$$

wherein P₂₀ is a value of P₂ at t=0.

Further, equation (2-3) is differentiated to obtain the following equation for the changes of P₂ with time:

$$\frac{d {P}_{2}}{d t} = - \frac{{P}_{N}}{V} \frac{π {D}^{4}}{128 μ L} ( {P}_{20} - {P}_{1} ) {e}^{- \frac{{P}_{N}}{V} \frac{π {D}^{4}}{128 μ L} t} . \qquad Equation ( 2 \text{-} 4 )$$

For example, when the fuel is hydrogen (μ=8.8×10⁻⁶ Pa/s) and the fuel cutoff device or the control value between the fuel cutoff device and the pressure sensor 4 is provided, the flow resistance of the fuel flow path from the control valve to the pressure sensor 4 equals that of a choke with a diameter of 0.06 mm and a length of 10 mm, and the volume V of a downstream portion is 1 cm³.

When the pressure P₂₀ measured by the pressure sensor 4 before fuel supply is 100 kPa and the supply pressure P₁ (pressure after control by the control value) from the fuel tank 1 is 150 kPa (normal condition) or 120 kPa (when the residual fuel amount decreases), changes in the pressure (P₂) over time measured by the pressure sensor 4 are as shown in FIG. 7B. The pressure in the fuel flow path 5 gradually increases with the supply of the fuel, and the pressure measured by the pressure sensor 4 becomes equal to the supply pressure after 10 seconds from the start of supplying the fuel. For example, when the pressure in the fuel tank 1 is lower than 130 kPa, the pressure measured by the pressure sensor 4 is lower than 130 kPa for about 2 seconds from the start of supplying the fuel even when the a sufficient amount of fuel remains (150 kPa). Therefore, during this time, the residual fuel amount cannot be accurately determined based on the supply pressure. That is, in this case, the method for judging the low-pressure abnormality of the pressure sensor described above on the basis of the flowchart of FIG. 5 becomes effective at least 2 seconds after the start of supplying the fuel to the fuel cell.

The pressure changes from t=1 second to t=2 seconds are 10.5 kPa and 4.2 kPa when the supply pressure of the fuel is 150 kPa and 120 kPa, respectively. For example, when a pressure change k for judging a decrease in the residual amount within this time period is 6 kPa, a decrease in the residual amount can be detected by a pressure change over time. In this case, as in the flowchart shown in FIG. 5, the outside temperature may be measured to account for the influence of temperature on pressure changes.

This system is capable of detecting a decrease in the residual amount until t is about 6 seconds. In other words, as shown in FIG. 8, a decrease in the residual amount can be judged by a pressure change over time up to the predetermined time t₁ from the start of supplying the fuel and can be judged by measuring the pressure after the predetermine time t₂. In this case, t₁ and t₂ may be the same or different. For example, in the case shown in FIG. 7A, t₁ and t₂ can be set to 3 seconds.

A fuel cell can have a fuel flow path with a structure in which an orifice and a choke are combined. Therefore, the flow resistance in the fuel cell is influenced by the orifice and the choke, but the tendency of the pressure changes is the same as in FIGS. 7A and 7B.

In an operating method in which the anode flow path is not opened to air when the operation of the fuel cell is stopped or hydrogen in the flow path is not consumed by the power generation, the pressure in the fuel flow path 5 is high for some time after the operation is stopped. In this state, when the fuel is again supplied to the cell, the rate of the pressure change over time while supplying the fuel is decreased.

This corresponds to a state in which in the graph of each of FIGS. 7A and 7B, a time when the pressure measured by the pressure sensor 4 equals the pressure in the flow path is considered as t=0. Therefore, in order to more precisely detect a decrease in the residual amount of the fuel, not only the pressure change over time, but also the value measured by the pressure sensor 4 are taken into consideration. For example, a pressure change is measured at a time when the value as measured by the pressure sensor is the predetermined value and is not based on the time elapsed from switching the fuel cutoff device from a cutoff state to a flow state. Therefore, the measurement performed by the pressure sensor 4 can be taken into consideration.

For example, in the case shown in FIG. 7A, a judgment may be made on the basis of a pressure change 0.1 second after the pressure value reaches 110 kPa. In this case, a pressure change can be measured according to the residual amount regardless of the pressure at the start of supplying the fuel. This method is capable of detecting a decrease in the residual amount with a higher degree of accuracy, because of a large difference between the pressure changes over time under normal conditions and those when the residual amount decreases.

Further, when the initial value measured by the pressure sensor 4 exceeds the predetermined value, a decrease in the residual amount may not be judged by a pressure change over time. That is, when the pressure measured by the pressure sensor 4 at the time supplying of fuel is initiated exceeds 110 kPa, detection is not performed by a pressure change over time. In this case, a residual amount may be judged by a pressure after the predetermined time t₂ elapsed.

This determination is effective not only for a fuel cell with an orifice, but also for the cell with a choke-shaped flow path, as shown in FIG. 7B. In other words, when the judgment is made on the basis of a pressure change per second after the pressure value reaches 110 kPa, a pressure change according to the residual amount can be detected regardless of the pressure at the start of supplying the fuel. Further, if the pressure value exceeds 110 kPa, the judgment is not made on the basis of a pressure change over time. A decrease in the residual amount is identified on the basis of the pressure value after the elapse of the predetermined time t₂.

Whether a decrease in the residual amount is detected by a pressure change with time may be judged by detecting the output voltage of the fuel cell instead of using the pressure value measured by the pressure sensor 4 at the start of supplying the fuel. That is, if the detected voltage is sufficiently higher (near the open-circuit voltage) than the predetermined voltage, it can be judged that a sufficient amount of hydrogen present in the fuel flow path. If there is an orifice and/or a choke, t₁ and t₂ tend to increase as the flow path resistance increases. Namely, in a design in which the resistance of the flow path from the fuel supply portion to the pressure sensor 4 is increased, it is effective to judge a decrease in the residual amount of the fuel on the basis of a pressure change over time at the start of supplying the fuel.

A case in which a tank filled with a hydrogen storing alloy is used as the fuel tank 1 is described below. When a sufficient amount of hydrogen is present the hydrogen storing alloy, the hydrogen dissociation pressure is slightly decreased due to a temperature decrease associated with a hydrogen release reaction (hydrogen is released from the hydrogen storing alloy via a hydrogen dissociation reaction). However, even if the fuel tank is small, the supply pressure of the fuel changes little. Further, when the pressure between the fuel tank 1 and the pressure sensor 4 is controlled, the fuel supply pressure is at a set value and is constant.

However, when the amount of stored hydrogen decreases to reduce the pressure in the tank, hydrogen present in a space in the tank is first released. Therefore, if the space is small, the hydrogen release pressure decreases substantially with the release. Therefore, even when the pressure between the fuel tank 1 and the pressure sensor 4 is controlled, the supply pressure cannot be maintained at a constant level if the supply pressure is lower than the set pressure of the control valve.

Although, in FIG. 7A or 7B, the hydrogen supply pressure is constant, the supply pressure decreases with the release of the fuel when the residual amount decreases. That is, in FIGS. 7A and 7B, a difference in the gradient of the curve between when the residual amount is sufficient and when the residual amount is insufficient is further increased, facilitating detection. With respect to the high-pressure abnormality, even in a transient state at the start of supplying the fuel, the same judgment as in a stationary state can be made.

### Second Embodiment

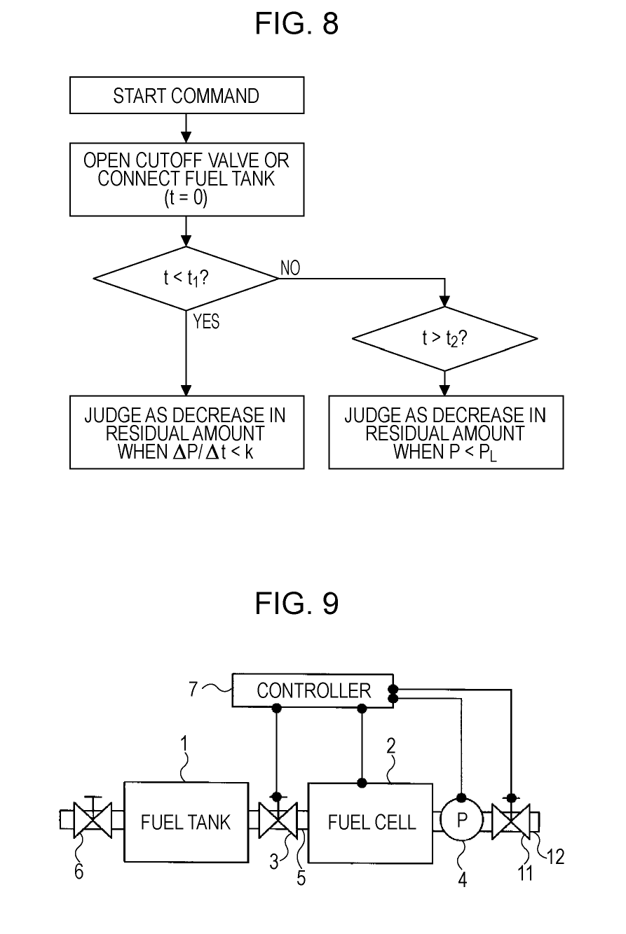

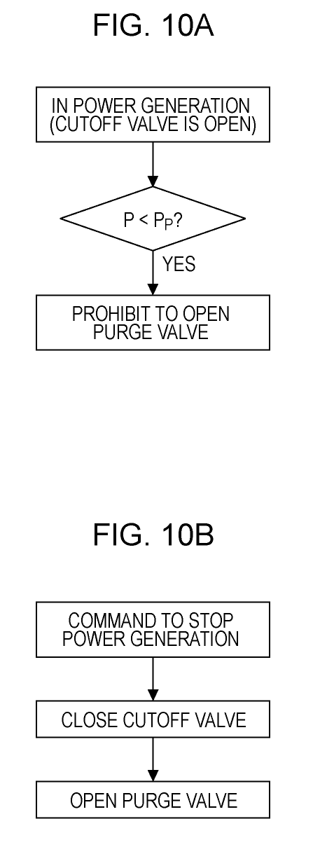

Next, a second embodiment of the present invention is described below. FIG. 9 shows a first configuration example of this embodiment. In FIG. 9, reference numeral 11 denotes a purge valve (fuel discharge valve). Reference numeral 12 denotes a discharge port. As described in the first embodiment, in this embodiment, a connector, a control valve, and a temperature sensor may be provided. The purge valve (fuel discharge valve) 11 is disposed at the flow path outlet of a fuel cell 2 and is usually closed during power generation. When impurities, such as nitrogen and water vapor, accumulate in the fuel flow path during power generation, a purge operation, i.e., opening and closing of the purge valve 11, is performed for discharging the impurities through the discharge port 12. However, as shown in FIG. 10A, when the pressure measured by the pressure sensor is lower than predetermined pressure P_{P}, the purge operation is prohibited. This is because when the pressure in the fuel flow path is low, air may flow in from the outside during the purging operation. Further, when the cutoff valve 3 is opened, the inflowing air may enter the fuel tank 1 and degrade the hydrogen storing alloy.

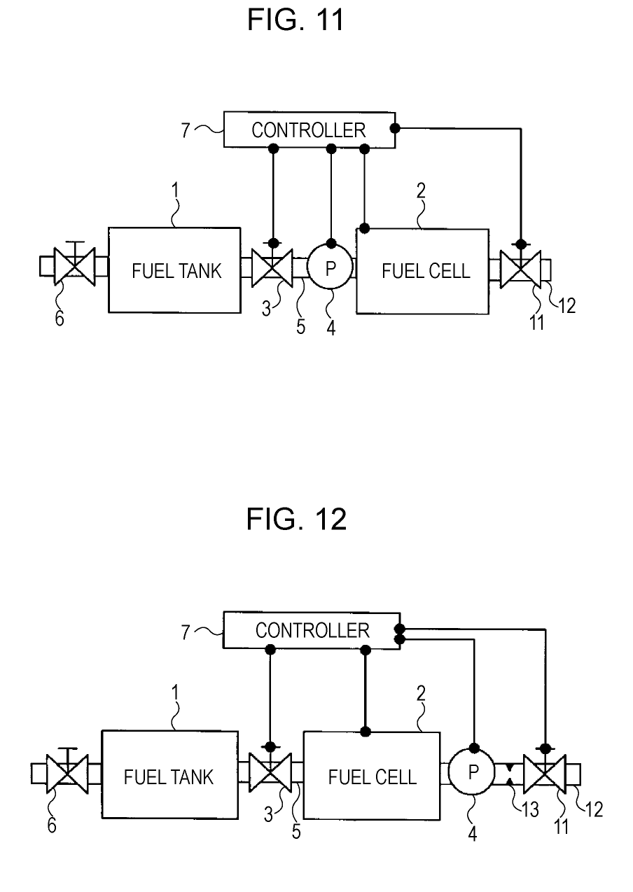

In addition, when power generation is stopped, the purge valve 11 may be opened for replacing the fuel in the fuel flow path with air. In this case, the cutoff valve 3 is closed, and then the purge valve 11 is opened. Even if the pressure in the fuel flow path is lower than P_{P}, the purge valve 11 may be opened as long as the cutoff valve 3 is closed (FIG. 10B). With respect to the positional relationship between the fuel cell 2 and the pressure sensor 4, either of the fuel cell 2 and the pressure sensor 4 may be provided upstream. However, when the resistance of the flow path from the pressure sensor 4 to the discharge port 12 is low, the value measured by the pressure sensor 4 decreases to near atmospheric pressure by opening the purge valve 11. Therefore, as a second configuration example of this embodiment, as shown in FIG. 11, the fuel cell 2 may be disposed downstream of the pressure sensor 4 in order to increase the flow path resistance downstream of the pressure sensor 4. FIG. 12 shows a third configuration example of this embodiment in which a throttle 13 is disposed as a high-pressure loss portion. The throttle 13 can alleviate a decrease in pressure measured by the pressure sensor 4 in the purge operation.

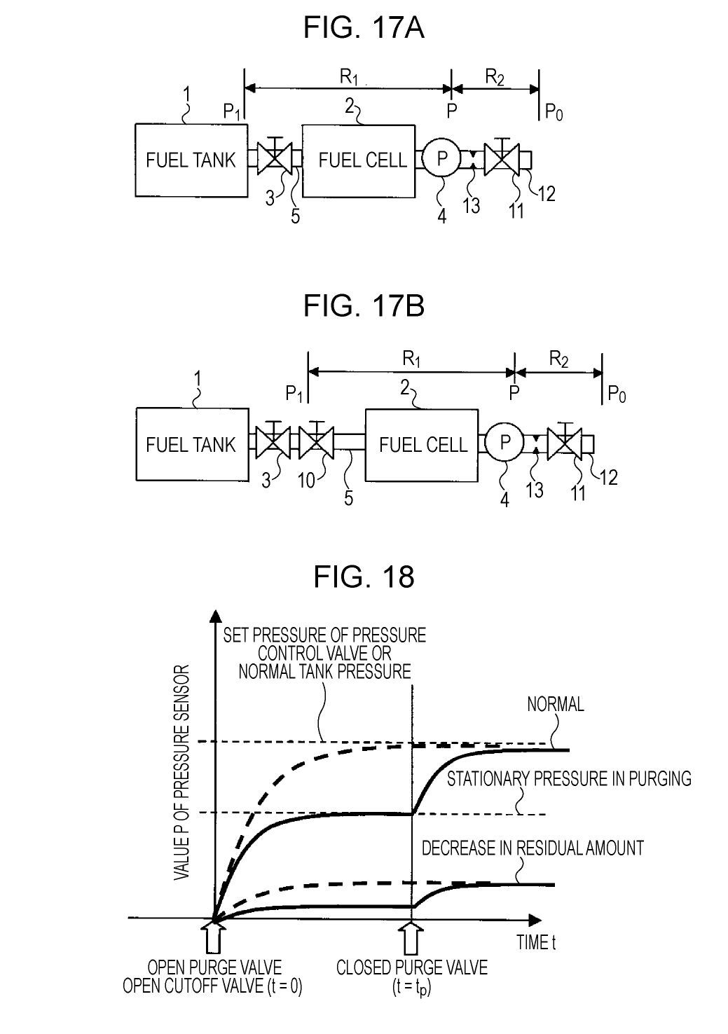

A relationship between the flow path resistance and the value measured by the pressure sensor 4 is described below. First, described is a case in which as shown in FIG. 17A, a control valve is not provided.

If a decrease in pressure due to fuel consumption in the fuel cell 2 is neglected, in an open state of the purge valve 11, P=P₀, wherein P is the pressure of the pressure sensor 4 and P₀ is atmospheric pressure. However, if a pressure loss in the flow path is proportional to the flow path resistance, the pressure decreases over time during purging and satisfies the following equation:

P=P₁−(P₁·P₀)×R₁/(R₁+R₂) Equation (3),

wherein P₁ is the pressure of the fuel tank 1, P₀ is atmospheric pressure, P is the pressure of the pressure sensor 4, R₁ is the resistance of the flow path from the fuel tank 1 to the pressure sensor 4, and R₂ is the resistance of the flow path from the pressure sensor 4 to the discharge port 12.

As shown in FIG. 17B, when the control valve 10 is provided, P can be represented by the same equation as that above, except that P₁ is the pressure downstream of the control valve 10, and R₁ is the resistance of the flow path from the outlet of the control valve 10 to the pressure sensor 4. When the residual amount of the fuel decreases to reduce the pressure in the fuel tank 1 below the control pressure, P₁ equals the pressure in the fuel tank 1. Therefore, a decrease in P during purging can be reduced by setting R₂ to be larger than R₁. Also a decrease in P can be reduced by shortening the purge time because P gradually decreases over time during purging.

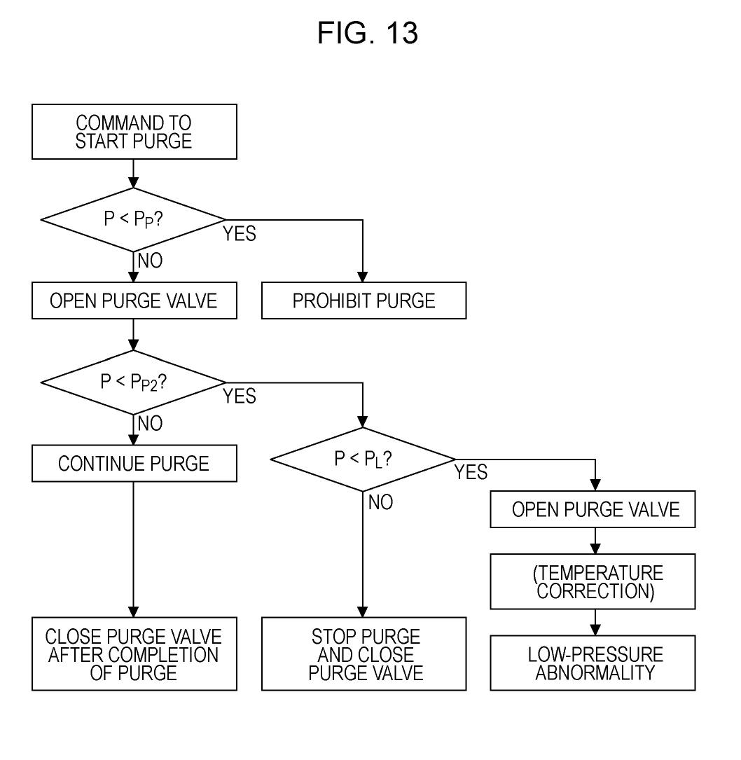

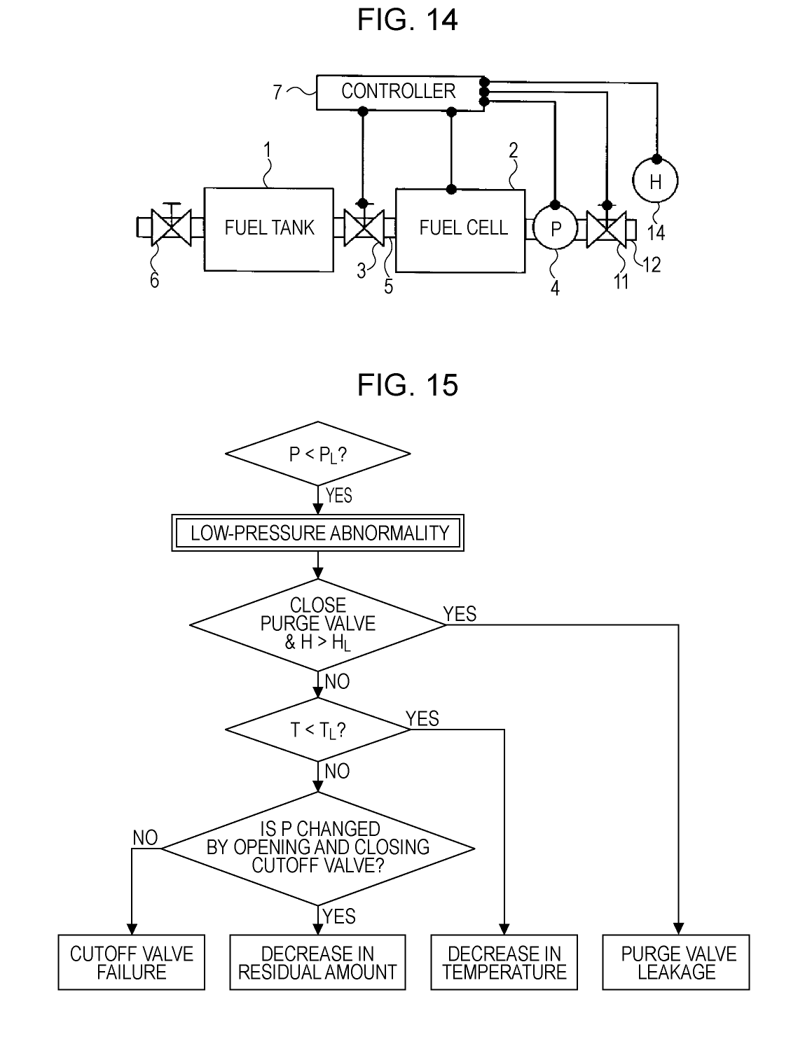

A flowchart of a purging process is shown in FIG. 13. During purging, the purge valve is closed when the pressure of the pressure sensor 4 is lower than predetermined pressure P_{P2}. As in the first embodiment, when the pressure is lower than P_{L}, this state is judged as a low-pressure abnormality. The processing routine for the low-pressure abnormality is the same as in the first embodiment. However, when the purge valve 11 is provided, the low-pressure abnormality may be due to leakage in the purge valve 11. When it is necessary to judge whether leakage occurred in the purge valve 11, as a fourth configuration example of the second embodiment, a hydrogen sensor 14 may be provided as a fuel sensor outside the fuel cell, for example, outside the fuel flow path, as shown in FIG. 14. Whether there is a leak in the purge valve 11 can be judged by using hydrogen sensor 14. A flowchart of the process when the low-pressure abnormality is detected is shown in FIG. 15.

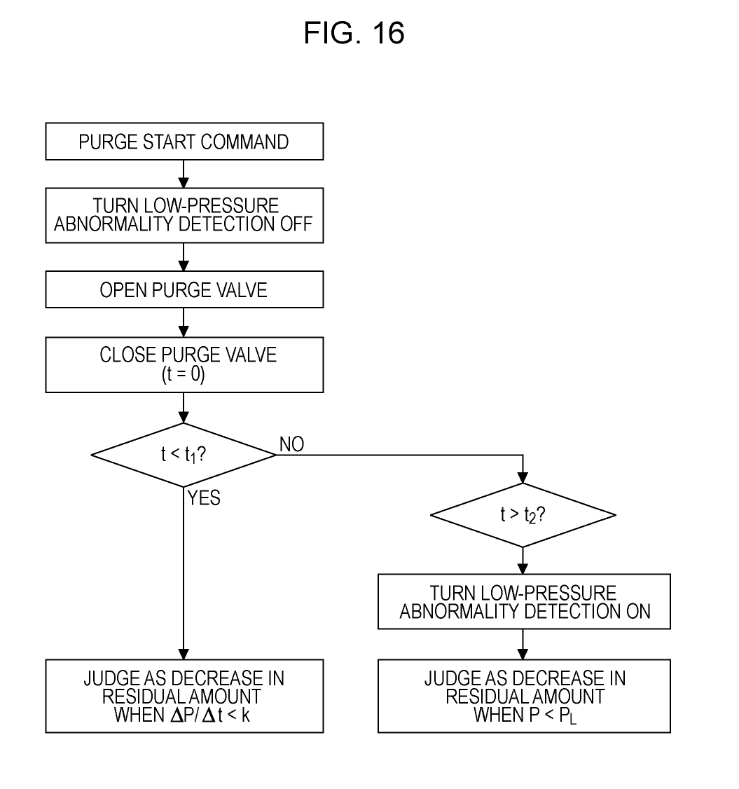

However, when the flow resistance downstream of the pressure sensor 4 is low (when P may be lower than P_{P2}), a decrease in the pressure measured by the pressure sensor 4 during purging is not judged as a low-pressure abnormality. That is, as shown in FIG. 16, low-pressure abnormality detection is turned off when a purge command is emitted, and the low-pressure abnormality detection is turned on after a predetermined amount of time has passed from the emission of the purge command or the closure of the open purge valve. Although this system is disadvantageous in that detection cannot be made when the fuel residual amount decreases during purging, the system is effective when a decrease in pressure measured by the pressure sensor 4 cannot be avoided because of a high purge flow rate.

In order to detect a decrease in the residual amount immediately after the closure of the purge valve, as in the first embodiment, a decrease in the residual amount can be detected by a change in pressure over time in a pressure recovery process after the purge valve 11 is closed. If electric power is not generated by the fuel cell, the relationship between the time and pressure in the pressure recovery process is the same as that shown in FIG. 7A or 7B according to equation (1-3) or (2-3) described in the first embodiment. In other words, the initial pressure during the stoppage is the pressure decreased during purging, which gradually increases according to the graph. Therefore, the method of detecting a residual amount by a pressure change over time can be easily applied to a case in which the pressure is further decreased during purging. Also, when the pressure measured by the pressure sensor 4 exceeds a predetermined value, a decrease in the residual amount may not be judged by a change over time.

When the pressure measured by the pressure sensor 4 in a closed state of the purge valve exceeds a predetermined value (e.g., 110 kPa), detection is not made using a pressure change over time. A decrease in the residual amount can be judged by the pressure after the elapse of the predetermined time t₂. In addition, whether there is a decrease in the residual amount is detected by a pressure change over time may be judged by detecting the output voltage of the fuel cell instead of using the pressure measured by the pressure sensor 4 in a closed state of the purge valve. That is, when the output (or the voltage) of the fuel cell is sufficiently higher than an estimated value, it can be judged that a sufficient amount of hydrogen is present in the fuel flow path.

When purging is performed during power generation by the fuel cell, a slight deviation from the graph in FIG. 7A or 7B occurs, because the fuel is consumed by power generation. In addition, the amount of the fuel consumed is proportional to the amount of power being generated. Thus, the degree of deviation depends on the amount of electric power generated. Therefore, when purging is performed during power generation, a decrease in pressure in the flow path during purging varies depending on the amount of electric power generated and is not constant. In addition, a decrease in pressure during purging depends on the purge time. Therefore, in order to judge a decrease in the residual amount of the fuel, the value from the pressure sensor 4 is also taken into consideration. For example, a pressure change is measured when the pressure measured by the pressure sensor is the predetermined value and not on the basis of the elapsed time from the stoppage of the purge valve. Therefore, the pressure measured by the pressure sensor 4 can be taken into consideration. For example, a judgment may be made on the basis of a pressure change per second after the pressure reaches 110 kPa. In this case, a pressure change can be measured according to the residual amount regardless of the decrease in pressure during purging. This method is capable of detecting a decrease in the residual amount with a higher degree of accuracy because of a large difference between the pressure changes over time under normal conditions and those when the residual amount decreases. In addition, even in a transient state during purging, the high-pressure abnormality described in the first embodiment can be judged in the same manner as in a stationary state.

### Third Embodiment

Next, a third embodiment of the present invention is described. The configuration of a fuel cell system according to this embodiment is the same as in the second embodiment. In this embodiment, a purge valve (fuel discharge valve) 11 is opened for replacing air in a fuel flow path with the fuel at the start of the operation of a fuel cell. In particular, in order to prevent excessive pressure from being applied to the flow path, the purge valve 11 is first opened after the start. Then, the supply of the fuel is started. After inner air is sufficiently exhausted, the purge valve 11 is closed and power generation is started. In this case, changes in pressure measured by a pressure sensor 4 are substantially as shown in FIG. 18. In other words, when a sufficient amount of fuel is present, the pressures changes in two steps, i.e., a step of approaching the stationary pressure in purging when the purge valve 11 is opened (t<tₚ) and then a step of approaching the supply pressure of the fuel after the purge valve 11 is closed (t>tₚ). The stationary pressure in purging is determined by equation (3) recited in the second embodiment. Further, the pressure increases after the purge valve 11 is closed according to equation (1-3) or (2-3) recited in the first embodiment. However, when the purge valve 11 is opened, the pressure increases more gradually than according to equation (1-3) or (2-3) (a dotted line graph in FIG. 18) due to the influence of the fuel discharged from the discharge port 12.

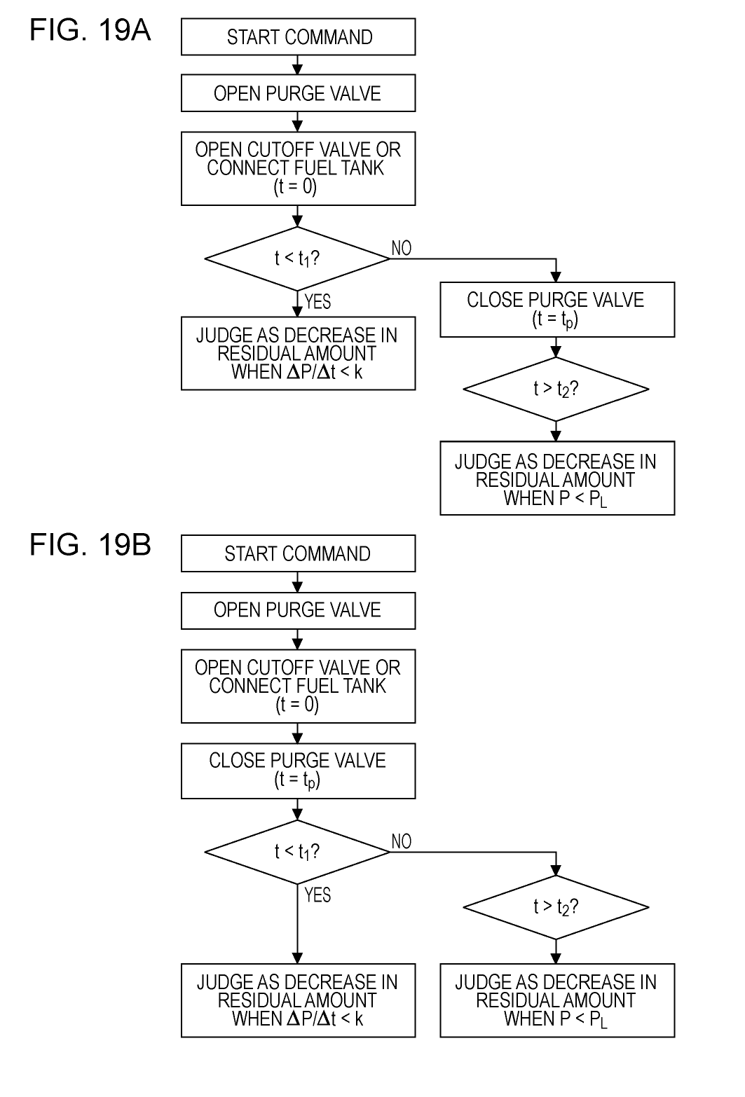

A method of judging a decrease in the residual amount of the fuel in the starting process of this embodiment is described below. First, in a first method shown in FIG. 19A, a decrease in the residual amount is judged on the basis of a change in pressure measured by the pressure sensor 4 over time when the purge valve is opened after supplying of the fuel is started. Further, when the pressure becomes constant after the purge valve 11 is closed, a decrease in the residual amount is judged on the basis of the value measured by the pressure sensor 4. However, in a second method shown in FIG. 19B, a decrease in the residual amount is judged on the basis of a change in value measured by the pressure sensor 4 over time in a transient state of a pressure increase after the fuel supplying is started and the purge valve is closed. Further, when the pressure reaches a stationary state, a decrease in the residual amount is judged on the basis of the value provided by the pressure sensor 4. That is, the methods shown in FIGS. 19A and 19B are different in that a decrease in the residual amount is detected by a pressure change over time in a transient state before or after the purge valve 11 is closed.

The preference between these methods depends on the magnitude of the stationary pressure during purging, which is determined by equation (3), and the time required from the start of supplying fuel to the closure of the purge valve 11. In other words, if the stationary pressure during purging is close to the supply pressure of the fuel, the method of FIG. 19A can be used, while if the stationary pressure during purging is substantially different from the supply pressure of the fuel, the method of FIG. 19B can be used. However, even if the stationary pressure during purging is close to the supply pressure of the fuel, when the pressure does not approach the stationary pressure until the purge valve is closed because of the short purge time (tₚ), as in the method shown in FIG. 19B, a pressure change over time after the purge valve is closed can be used. Specifically, in the configurations of the flow resistance shown in FIGS. 17A and 17B, when R₁ is smaller than R₂, the method of FIG. 19A can be used. When R₁ is larger than R₂, the method of FIG. 19B can be used. However, even if R₁ is smaller than R₂, when the value measured by the pressure sensor 4 at tₚ under normal supply pressure is less than ½ of the supply pressure in a stationary state, the method of FIG. 19B can be used.

As described in the first embodiment, in an operating method in which the anode flow path is opened to air when the power generation of the fuel cell is stopped or hydrogen in the flow path is not consumed by the power generation, the pressure in the fuel flow path 5 is high for an extended period of time. That is, when the starting method of this embodiment is used, the pressure in the fuel flow path can be made close to atmospheric pressure by opening the purge valve 11. A decrease in the residual amount of the fuel can be more precisely judged by a pressure change over time.

As can be seen from the description of each of the embodiments of the present invention, the present invention relates to a device for judging a pressure abnormality of a fuel cell, and particularly to the judgment of a decrease in the residual amount of the fuel and a valve failure by using a pressure detecting device. Also, the present invention relates to a method for controlling a fuel cell system including the pressure detecting device. According to the present invention, the durability and convenience of a fuel cell can be improved by providing a fuel cutoff device, such as a cutoff valve, and a connector between a fuel tank and a generation portion of the fuel cell. Further, a pressure detecting device is provided downstream of the fuel cutoff device so that a residual amount and a valve failure can be detected by the single pressure detecting device. As a result, the size and the cost of the system can be reduced.

### EXAMPLE

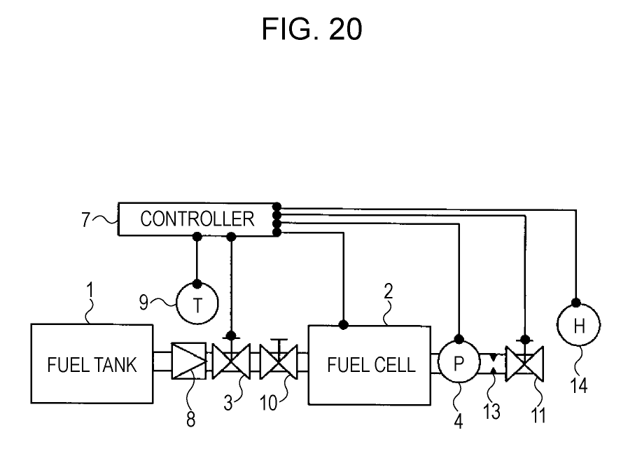

An example of the present invention is described below. FIG. 20 is a schematic drawing illustrating a fuel cell system of this example. In FIG. 20, the components denoted by the same reference numerals as in the first to third embodiments are not described.

In this example, the fuel tank 1 is about 20 cm³. The fuel tank is filled with LaNi₅ powder, which is a hydrogen storing alloy. LaNi₅ can adsorb and desorb about 1.1 wt % of hydrogen. About 5 NL of hydrogen can be stored in the tank 1. This corresponds to about 8 Whr of energy when the power generation efficiency of the fuel cell is about 50%. Although the hydrogen dissociation pressure depends on temperature and is about 150 kPa (abs) at room temperature, the pressure is lower than atmospheric pressure at 0° C. and increases to about 400 kPa (abs) at 50° C. In addition, about 30 kJ of heat is absorbed by the release of 1 mol of hydrogen. The pressure in the fuel tank 1 is substantially constant (plateau region) in a wide residual amount range at a constant temperature, but when the residual amount decreases to about 10%, the pressure in the tank decreases.

The fuel tank 1 is detachably connected to the fuel cell 2 through the connector 8. In particular, a stop valve device (check valve) is provided on the fuel tank side of the connector. Therefore, when the connector 8 is disconnected, the release of hydrogen to air and mixing with air in the fuel tank 1 can be prevented. When the fuel tank 1 is filled with fuel, the fuel tank 1 is separated from the fuel cell system, and the fuel is supplied through the fuel tank-side connector part of the separated connector 8.

The cutoff valve 3 is provided downstream of the connector 8 and opening/closing of the cutoff valve 3 can be controlled by the controller 7. A solenoid valve can be used as the cutoff valve 3. The cutoff valve is generally closed when the operation of the fuel cell is stopped and is opened when a power generation command is given. The control valve 10 is provided downstream of the cutoff valve 3. The control valve 10 is a pressure-reducing valve (regulator) for reducing downstream pressure to about 50 kPa (G). Even when the hydrogen pressure in the fuel tank 1 increases due to an increase in temperature of the fuel tank 1, the control valve 10 prevents high pressure from being applied to the fuel cell 2. However, when the pressure in the fuel tank 1 decreases to be lower than the set pressure of the control valve 10 as the residual amount of the fuel or in the temperature of the tank 1 decreases, the downstream pressure of the control valve 10 equals the upstream pressure. Therefore, the fuel passing through the control valve 10 is supplied to the fuel cell 2.

Air is supplied to a cathode of the fuel cell 2 by natural diffusion (not shown). The air may be supplied using a fan or the like when the quantity of generated electricity is large. When the fuel cell 2 is connected to an outside load (small electric apparatus), electric power is generated by a reaction between hydrogen of the anode and oxygen (air) of the cathode in the fuel cell. When about 10 W of power is generated, about 100 cc/min of hydrogen is consumed as fuel. When about 100 cc/min of hydrogen is consumed, the temperature of the fuel tank 1 decreases to be about 15° C. lower than ambient temperature by an endothermic reaction caused by the release of hydrogen. However, the fuel cell 2 generates heat (in this case, about 10 W) substantially equal to the generated electricity. Therefore, a decrease in temperature of the fuel tank 1 can be prevented by a heat exchange between the fuel tank 1 and the fuel cell 2. The water generated by the power generation reaction humidifies the electrolyte film and is released as water vapor to the outside air.

In addition, the purge valve (fuel discharge valve) 11 is provided in the fuel flow path and is opened and closed by a command from the controller 7 according to the power generation conditions and time. The pressure sensor 4 is also provided in the fuel flow path, and the throttle 13 is provided downstream of the pressure sensor 4. On the basis of the pressure measured by the pressure sensor 4, the controller 7 judges that there is a high-pressure abnormality when the value exceeds, for example, 100 kPa (G) and judges that there is a low-pressure abnormality when the value is lower than 20 kPa (G). Further, the temperature sensor 9 is provided in the fuel cell system in order to monitor the temperature of the external environment. Further, the hydrogen sensor 14 is provided so that when about 1 vol % of hydrogen is detected, this state is judged as a leakage. When hydrogen leaks, a user is informed of the leakage, and the cutoff valve 3 is closed to safely stop the system. The controller 7 monitors the output (or voltage) of the fuel cell 2, values provided by the pressure sensor 4, the temperature sensor 9, and the hydrogen sensor 14, and open/close states of the valves. It also controls the output and opening/closing of the cutoff valve 3 and the purge valve 11. When other actuators, such as a sensor and a fan, are provided, the controller 7 controls these actuators.

The operation of a pressure abnormality judging device of the present invention in the above-described system is described below. The cutoff valve 3 is closed when power generation is stopped. The purge valve 11 may be either opened or closed during the stoppage. Even when the purge valve 11 is closed, when the fuel cell is not used for a long time, nitrogen enters the anode flow path due to permeation through the electrolyte film. At the same time, the pressure is lower than that during a typical power generation process. In this example, the same system as described above in the third embodiment is used, in which the purge valve 11 is opened at the start, and then the supplying of the fuel is started.

When a command to start power generation is given, as shown in FIG. 19A, the purge valve 11 is first opened. One second later, the cutoff valve 13 is opened. The pressure in the fuel flow path reaches atmospheric pressure within 1 second. Then, the purge valve 11 is closed after 5 seconds from the opening of the cutoff valve 3. When a sufficient amount of the fuel is present, the pressure measured by the pressure sensor 4 increases to about 30 kPa (G) within 5 seconds. Therefore, impurity gases in the fuel flow path are discharged and replaced with the fuel gas. In addition, pressure changes over time are measured from 1 to 2 seconds after the opening of the cutoff valve 3 to detect a residual fuel amount. If a pressure change per second does not exceed k=5 kPa/s at the outside air temperature of about 20° C. to 25° C., it is judged that the residual fuel amount is insufficient. If the outside air temperature is lower than this, k is corrected to a smaller value so that when a pressure change is larger than the set value, it is judged that the temperature is abnormal. When a pressure change is smaller than the set value, it is judged that the residual amount is insufficient. However, when the pressure is insufficient due to a decrease in temperature, a user is informed of this state.

After the purge valve 11 is closed, the pressure gradually increases and settles down at about the control pressure (50 kPa (G)) of the control valve 10. However, there is a pressure loss in the flow path, and the pressure measured by the pressure sensor 4 decreases to about 45 kPa (G) as the amount of electricity generated increases. In consideration of a pressure decrease due to fuel loss, the set pressure of the pressure-reducing valve may be about 60 kPa (G). After the purge valve 11 is closed, a judgment on a low-pressure abnormality by a pressure value from the pressure sensor 4 is initiated. That is, when the value from the pressure valve 4 is lower than P_{L} (20 kPa (G)), a judgment is made on the basis of the flowcharts of FIGS. 5 and 15. Namely, when the value H provided the hydrogen sensor exceeds H_{L} (1 vol %), it is judged that there is a leak. In this case, a user is informed of this condition, and the cutoff valve 3 is closed to stop power generation. Next, when the value from the temperature sensor 9 is lower than T_{L}, it is judged that the fuel pressure decreases due to a decrease in temperature. Next, the cutoff valve 3 is opened and closed to measure pressure changes. If no difference is observed between the rates of pressure changes, it is judged that the flow path is cut off even through an open command was given to the cutoff valve 3. This indicates that any one of the connector 8, the cutoff valve 3, and the control valve 10 is cut off.

In a case other than the one described above, it is judged that a residual amount in the fuel tank 1 decreases, and a user is informed of this condition. According to circumferences, power generation is stopped, and the cutoff valve 3 is closed. In addition, nitrogen and water vapor accumulated in the anode of the fuel cell through the electrolyte film in association with power generation. Therefore, purging is required to maintain an optimum power generation state. The purging may be performed at a predetermined time interval (for example, every half-hour) or performed when the output decreases. When a purge command is given during power generation, purging is performed on the basis of the flowchart of FIG. 13. First, whether the pressure measured by the pressure sensor 4 is less than the predetermined value P_{P} (for example, 30 kPa (G)) is checked. If the value is lower than P₂, purging is prohibited. Next, when the pressure decreases to be lower than the second predetermined pressure P_{P2} (for example 25 kPa (G)) during purging after the purge valve is opened, the purging is stopped. Further, when the pressure is lower than P_{T} (20 kPa (G)), the pressure is judged as a low-pressure abnormality. The purging may be finished after the elapse of a predetermined period of time or on the basis of an output change of the fuel cell or the value from the pressure sensor 4. The judgment on the low-pressure abnormality is performed in the same manner as described above on the basis of the flowcharts of FIGS. 5 and 15. In this example, when the value from the pressure sensor 4 before the start of purging is 50 kPa (G), the value from the pressure sensor 4 at the end of purging is about 40 kPa (G), because of the throttle provided downstream of the pressure sensor 4. In addition, the purge flow rate is kept at about 80 cc/min. The sufficient purge time is about 1 to 5 seconds depending on the dimensions of the flow path. Further, the frequency of purging may be increased by shortening the purge time.

However, unlike in this example, when the throttle 13 is not provided to decrease the flow path resistance downstream of the pressure sensor 4, the method described with reference to FIG. 16 is effective. In this case, when the purge valve 11 is opened, the controller 7 does not judge there to be a low-pressure abnormality even if the value from the pressure sensor 4 is low. In addition, the time required to go from the opening of the purge valve to pressure recovery can be set to, for example, about 10 seconds depending on the dimensions of the flow path. When the pressure during power generation is higher than P_{H} (100 kPa (G)), this pressure state is judged as a high-pressure abnormality on the basis of FIG. 6A. A main cause of the high-pressure abnormality is a failure (leakage) of the control valve 10. The judgment on the high-pressure abnormality may be made even when the judgment on the low-pressure abnormality is stopped. When a command to stop power generation is given to the fuel cell, the fuel cell is separated from a load, and the cutoff valve is closed. When the operation of the fuel cell is stopped, the purge valve 11 may be opened, as shown in FIG. 10B. Since the cutoff valve 3 is closed during the stoppage, the pressure sensor 4 cannot monitor the pressure of the fuel tank 1. Thus, the judgment on the low-pressure abnormality is not made. Further, when the residual amount decreases, the fuel tank 1 is separated from the connector 8 and is exchanged for a new tank.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Application No. 2007-289289 filed Nov. 7, 2007, which is hereby incorporated herein by reference in its entirety.

What is claimed is:

1. A method for judging a system condition in a fuel cell system, the fuel cell system comprising a fuel cutoff device provided in a fuel flow path for supplying fuel to a fuel cell from a fuel tank, a pressure detecting device provided downstream of the fuel cutoff device, and a pressure condition judging device for judging a pressure condition based on information from the pressure detecting device, the method comprising:
a step of detecting a pressure change per unit time within a predetermined period of time by the pressure detecting device after the fuel cutoff device is switched from a cutoff state to a flow state, and
a step of judging, by the pressure condition judging device, whether an amount of fuel in the fuel tank is smaller than a predetermined residual amount by comparing the pressure change per unit time detected by the pressure detecting device with a predetermined pressure change.

2. The method according to claim 1, wherein, in the step of detecting a pressure change, the pressure change per unit time is detected after a predetermined amount of time has passed from switching the fuel cutoff device from the cutoff state to the flow state.

3. The method according to claim 1, wherein, in the step of detecting a pressure change, the pressure change per unit time is detected after the pressure detecting device detects a predetermined pressure.

4. The method according to claim 1, comprising judging that the amount of the fuel remaining in the fuel tank is smaller than the predetermined residual amount when the pressure change per unit time detected by the pressure detecting device is lower than the predetermined pressure change.

5. The method according to claim 1, wherein when, in the step of detecting a pressure change, a pressure detected by the pressure detecting device before the fuel cutoff device is switched from the cutoff state to the flow state is higher than a predetermined pressure, the pressure condition judging device does not judge that the amount of the fuel in the fuel tank is smaller than the predetermined residual amount even if the pressure change per unit time detected by the pressure detecting device is lower than the predetermined pressure change.

6. The method according to claim 1, wherein when, in the step of detecting a pressure change, a voltage produced by the fuel cell detected before the fuel cutoff device is switched from the cutoff state to the flow state is higher than a predetermined voltage, the pressure condition judging device does not judge that the fuel amount in the fuel tank is smaller than the predetermined residual amount even if the pressure change per unit time detected by the pressure detecting device is lower than the predetermined pressure change.

7. The method according to claim 1, wherein the fuel cell system includes a fuel discharge valve, a discharge port for discharging the fuel in the fuel flow path, and, optionally, a control valve between the fuel tank and the pressure detecting device, so that when the fuel flow path has such a flow resistance that a pressure calculated according to formula (1) is larger than a predetermined pressure of the fuel discharge valve in a closed state, the fuel cutoff device is in a flow sate and the fuel discharge valve is in an open state, and if the pressure detected by the pressure detecting device is lower than the predetermined pressure, the pressure condition judging device gives a command to close the fuel discharge valve:
P₁−(P₁−P₀)×R₁/(R₁+R₂) (1),
wherein P₀ is atmospheric pressure, and R₂ is a resistance of the flow path from the pressure detecting device to the discharge port,
wherein, when the control valve is provided, P₁ is a pressure after control by the control valve, and R₁ is a resistance of the flow path from an outlet of the control valve to the pressure detecting device, and
wherein, when the control valve is not provided, P₁ is a pressure in the fuel tank, and R₁ is a resistance of the flow path from the fuel tank to the pressure detecting device.

8. The method according to claim 1, wherein the fuel cell system includes a control valve for controlling a flow rate or pressure between the fuel tank and the pressure detecting device and a fuel discharge valve for discharging the fuel in the fuel flow path, so that when a pressure detected by the pressure detecting device is lower than a predetermined pressure, an operating method of closing the fuel discharge valve is used, and a time required from opening to closing the fuel discharge valve is set to be shorter than a time required for the pressure detected by the pressure detecting device to decrease to the predetermined pressure when the fuel discharge valve is opened and the fuel is supplied by a control pressure of the control valve.

9. A method for judging a system condition in a fuel cell system, the fuel cell system comprising a fuel cutoff device provided in a fuel flow path for supplying fuel to a fuel cell from a fuel tank, a pressure detecting device provided downstream of the fuel cutoff device, and a pressure condition judging device for judging a pressure condition based on information from the pressure detecting device, the method comprising:
a step of detecting a pressure by the pressure detecting device after a predetermined amount of time has passed from a switch of the fuel cutoff device from a cutoff state to a flow state, and
a step of judging, by the pressure condition judging device, whether an amount of fuel in the fuel tank is smaller than a predetermined residual amount by comparing the pressure detected by the pressure detecting device with a predetermined pressure.

10. The method according to claim 9, wherein the judging step further comprises comparing at least one of a voltage and output of the fuel cell with a predetermined voltage or output.

11. The method according to claim 10, comprising judging, by the pressure condition judging device, that the amount of the fuel in the fuel tank is smaller than the predetermined residual amount when the pressure detected by the pressure detecting device is lower than the predetermined pressure and at least one of the voltage and output of the fuel cell is lower than the predetermined voltage or output.

12. The method according to claim 9, wherein the fuel cell system includes a fuel sensor provided outside the fuel flow path so that when the pressure detected by the pressure detecting device is lower than the predetermined pressure, the pressure condition judging device judges that there is a fuel leak if a value detected by the fuel sensor exceeds a predetermined value and the pressure condition judging device judges that the amount of the fuel in the fuel tank is smaller than the predetermined residual amount if the value detected by the fuel sensor does not exceed the predetermined value.

13. The method according to claim 9, wherein, when the pressure detected by the pressure detecting device is lower than the predetermined pressure, the fuel cutoff device is opened and closed to compare rates of pressure changes per unit time when the cutoff device is opened and closed so that when a difference between the rates of pressure changes per unit time does not exceed a predetermined value, the pressure condition judging device judges that there is a failure of the fuel cutoff device, and when the difference between the rates of pressure changes per unit time exceeds the predetermined value, the pressure condition judging device judges that the amount of the fuel in the fuel tank is smaller than the predetermined residual amount.

14. A method for judging a system condition in a fuel cell system, the fuel cell system comprising a fuel cutoff device provided in a fuel flow path for supplying fuel to a fuel cell from a fuel tank, a pressure detecting device provided downstream of the fuel cutoff device, and a pressure condition judging device for judging a pressure condition based on information from the pressure detecting device, the method comprising:
a step of detecting a pressure change per unit time by the pressure detecting device until a predetermined amount of time passes from a switch of the fuel cutoff device from a cutoff state to a flow state, and detecting a pressure by the pressure detecting device after the predetermined amount of time has passed, and
a step of judging, by the pressure condition judging device, whether an amount of fuel in the fuel tank is smaller than a predetermined residual amount by comparing the pressure change detected by the pressure detecting device with a predetermined pressure change, and comparing pressure detected by the pressure detecting device after the predetermined amount of time has passed with a predetermined pressure.

15. The method according to claim 14, comprising judging that the amount of the fuel remaining in the tank is smaller than the predetermined residual amount when the pressure change detected by the pressure detecting device is lower than the predetermined pressure change and when the pressure detected by the pressure detecting device after the predetermined amount of time has passed is lower than the predetermined pressure.

16. The method according to claim 14, wherein the fuel cell system includes a fuel discharge valve for discharging the fuel in the fuel flow path so that when the fuel discharge valve is opened, the pressure condition judging device does not judge that the amount of the fuel in the fuel tank is smaller than the predetermined residual amount even if the pressure change per unit time detected by the pressure detecting device is lower than the predetermined pressure change or the pressure detected by the pressure detecting device is lower then the predetermined pressure.

17. A method for judging a system condition in a fuel cell system, the fuel cell system comprising a fuel flow path for supplying fuel to a fuel cell from a fuel tank, a fuel cutoff device provided in the fuel flow path, a pressure detecting device provided downstream of the fuel cutoff device, a pressure condition judging device for judging a pressure condition based on information from the pressure detecting device, and a fuel discharge valve for discharging the fuel in the fuel flow path, the method comprising:
a step of detecting a pressure change per unit time by the pressure detecting device within a predetermined time after a switch of the fuel discharge valve from an opened state to a closed state when he fuel cutoff device is in the flow state, and
a step of judging, by the pressure condition judging device, whether an amount of fuel in the fuel tank is smaller than a predetermined residual amount by comparing the pressure change per unit time detected by the pressure detecting device with a predetermined pressure change.

18. The method according to claim 17, comprising judging that the amount of the fuel in the fuel tank is smaller than a predetermined residual amount when the pressure change per unit time detected by the pressure detecting device is lower than the predetermined pressure change.

19. The method according to claim 17, wherein, in the step of detecting the pressure change, the pressure change per unit time is detected after a predetermined amount of time has passed from the switch of the fuel discharge valve from the opened state to the closed state.

20. The method according to claim 17, wherein, in the step of detecting the pressure change, the pressure change per unit time is detected after a pressure measured by the pressure detecting device is at a predetermined value after the switch of the fuel discharge valve from the opened state to the closed state.

21. The method according to claim 17, wherein when, in the step of detecting a pressure change, pressure detected by the pressure detecting device before the switch of the fuel discharge valve from the opened state to the closed state is higher than a predetermined pressure, the pressure condition judging device does not judge that the amount of the fuel in the fuel tank is smaller than the predetermined residual amount even if the pressure change per unit time detected by the pressure detecting device is lower than the predetermined pressure change.

22. The method according to claim 17, wherein when, in the step of detecting a pressure change, a voltage generated by the fuel cell detected before the switch of the fuel discharge valve from the opened state to the closed state is higher than a predetermined voltage, the pressure condition judging device does not judge that the amount of the fuel in the fuel tank is smaller than the predetermined residual amount even if the pressure change per unit time detected by the pressure detecting device is lower than the predetermined pressure change.

23. A method for judging a system condition in a fuel cell system, the fuel cell system including a fuel flow path for supplying fuel to a fuel cell from a fuel tank, a fuel cutoff device provided in the fuel flow path, a pressure detecting device provided downstream of the fuel cutoff device, a pressure condition judging device for judging a pressure condition based on information from the pressure detecting device, and a fuel discharge valve for discharging the fuel in the fuel flow path, the method comprising:
a step of detecting a pressure by the pressure detecting device when the fuel cutoff device is in a flow state and after a predetermined amount of time has passed from a switch of the fuel discharge valve from an opened state to a closed state, and
a step of judging, by the pressure condition judging device, whether an amount of the fuel in the fuel tank is smaller than a predetermined residual amount by comparing a pressure detected by the pressure detecting device with a predetermined pressure.

24. The method according to claim 23, comprising judging that the amount of the fuel in the fuel tank is smaller than the predetermined amount when the pressure detected by the pressure detecting device is lower than the predetermined pressure.

25. The method according to claim 23, wherein the judging step further comprises comparing one of a voltage and output of the fuel cell with a predetermined voltage or output.

26. The method according to claim 25, comprising judging, by the pressure condition judging device, that the fuel amount in the fuel tank is smaller than the predetermined residual amount when the pressure detected by the pressure detecting device is lower than the predetermined pressure and at least one of the voltage and output of the fuel cell is lower than the predetermined voltage or output.
